(19) United States
(12) Patent Application Publication
(10) Pub. No.: US 2011/0044320 A1
(43) Pub. Date: Feb. 24, 2011

(54) MECHANISM FOR FAST EVALUATION OF POLICIES IN WORK ASSIGNMENT

(75) Inventors: Andrew D. Flockhart, Thornton, CO (US); Robert C. Steiner, Broomfield, CO (US)

Correspondence Address: SHERIDAN ROSS P.C., 1560 BROADWAY, SUITE 1200, DENVER, CO, 80202, US

(73) Assignee: AVAYA INC., Basking Ridge, NJ (US)

(21) Appl. No.: 12/545,413

(22) Filed: Aug. 21, 2009

(51) Int. Cl. H04L 12/66

(52) U.S. Cl. 370/352

(57) ABSTRACT

A work item routing mechanism is provided that is capable of employing a state map which compresses routing decisions and results of comparisons into a single bit. Thus, comparisons and determinations made in connection with work item routing are made prior to the routing mechanism receiving a work item. Once a work item is received, the routing mechanism only has to refer to the bit map to see if it is allowed to route the work item to a particular processing resource and if that resource is the best among all candidate processing resources. All of the work item routing decisions can, therefore, be made very quickly thereby reducing processing delay and wait time.

### FIELD

The present invention is directed generally to work item routing such as in contact centers.

### BACKGROUND

Contact centers are employed by many enterprises to service customer contacts. A typical contact center includes a switch and/or server to receive and route incoming packet-switched and/or circuit-switched contacts and one or more resources, such as human agents and automated resources (e.g., Interactive Voice Response (IVR) units), to service the incoming contacts. Contact centers distribute contacts, whether inbound or outbound, for servicing to any suitable resource according to predefined criteria. In many existing systems, the criteria for servicing the contact from the moment that the contact center becomes aware of the contact until the contact is connected to an agent are customer-specifiable (i.e., programmable by the operator of the contact center), via a capability called vectoring. Normally in present-day ACDs when the ACD system's controller detects that an agent has become available to handle a contact, the controller identifies all predefined contact-handling queues for the agent (usually in some order of priority) and delivers to the available agent the highest-priority oldest contact that matches the agent's highest-priority queue.

Most work assignment or routing engines used in contact centers currently consider many different variables when making a routing decision. When a new work item is received at the routing engine, the routing engine applies a routing algorithm that usually requires the routing engine to refer to specific state information for potential targets as well as consider other factors such as bandwidth, total processing capacity vs. capacity in use by the potential target, and so on. Obtaining all of this information takes time and utilizes valuable and scarce resources (network bandwidth due to messaging exchange). Also, routing decisions experience a natural delay while the relevant information is gathered and processed by the routing engine. This problem is amplified when work items are routed between physically disparate networks (e.g., a call center and a remote call center). The sharing of state information in these networks can take a significant amount of time.

Further exacerbating the problem is that since a work item or a resource may be considered many times for possible matches, the information regarding the match may be requested multiple times and computed multiple times (once for each evaluation). For instance, every time a resource becomes available, that resource can be tested for best match to tens of thousands of possible work items. All of this information must be retrieved and computed for each work item considered. As can be appreciated, this introduces a significant amount of delay in work item processing which may not be tolerated by customers and other users of contact centers and the like.

### SUMMARY

It is thus one aspect of the present invention to employ a routing engine that is capable of performing a bit value comparison between two or more bit tables to make a work item routing decision. A routing engine, in accordance with at least some embodiments of the present invention, is able to make fast logical operations (such as routing decisions) based on a comparison of a bit value for the work item with a corresponding bit value for a candidate processing resource.

In accordance with at least some embodiments of the present invention, a bit value for the work item represents processing needs of the work item and the corresponding bit value for the candidate processing resource represents an ability of the candidate processing resource to meet the work item's processing need. In accordance with at least some embodiments of the present invention, the bit value for the candidate processing resource is a value representing results of a decision algorithm which has been applied prior to the routing engine receiving the work item. In other words, a bit value for the candidate processing resource represents results of a decision algorithm which includes as an input at least some state information for the processing resource as well as a comparison of the state information against some rule or set of rules. The decision algorithm outputs a binary value and includes that value in the bit location of the candidate processing resource's bit table.

In accordance with at least some embodiments of the present invention, the routing engine may also be adapted to scan bit tables associated with a plurality of different processing resources to make a work item routing decision. The bit tables of each processing resource may be configured in a predetermined fashion, possibly having the bit positions dictated by one or more business rules or context-based rules depending upon the processing needs of the work item. When the bit tables of each processing resource comprises such a configuration, the routing engine is capable of identifying a best processing resource among the plurality of processing resources by scanning all of the bit tables and determining that one of the bit tables has a non-zero bit value (also referred to as positively identifying bit value) in a higher bit position than all other bit tables. The processing resource corresponding to the bit table having the non-zero bit value at the highest bit position can be identified as the best processing resource for the work item without any further determination.

In accordance with at least some embodiments of the present invention, an enabled context map is used to determine which resources (and their corresponding states) should be considered. If a resource is to be included in the enabled context map, then the bits used to make a routing decision for that resource are included in the enabled context map.

There may be several rules that are used to determine the value of a bit in the context map, but the ultimate value of the bit is information which is considered by the routing engine. When a work item is received, the routing engine can search through the context maps in a predetermined fashion, possibly according to business rules or rules dictated by needs of the work item, and when it finds a bit, or sequence of bits, that indicates it can make a routing decision, it will route the work item to that resource.

In accordance with at least some embodiments of the present invention, Boolean operations can also be used to either define the order in which context maps are searched or define the way in which context maps are modified such that they can be systematically scanned by the routing engine. No further determinations, calls for information, or comparisons are necessary.

In accordance with at least some embodiments of the present invention, an excluded context map may also be employed. If the work item dictates that certain resource attributes are not allowed, then the excluded context map can be created and any resource having a bit value match a bit value in the excluded context map will be automatically disqualified as a possible target resource.

In accordance with at least some embodiments of the present invention, a focus context map can also be used to make a policy decision or routing decision based on what is currently in focus. The bits in the focus context map define certain focus considerations and can help refine routing decisions, again without requiring the application of policy-based rules every time a routing decision is made. Only when the state of a resource changes such that the rules cause a change in routing requirements will the associated bit value in the context map change. In other words, the routing engine is not necessarily required to proactively request state and other information from resources, but will rather be enabled to rely on bit values which are changed in response to the resource initiating a communication that causes such a change. The resources may be adapted to initiate such a communication only when certain business rules are satisfied, such as when their state changes from one state to another state. It may be desirable to define such business rules in a way that minimizes the number of times that a bit value changes. This can also decrease the communications between the resources and the routing engine.

In addition, context maps can be changed dynamically (by administrative provisioning). Various user-defined rules can be used to interpret valid contexts for matching, determining exclusivity, and changing context maps. Other types of context maps can also be utilized including, without limitation, . . . .

While embodiments of the present invention may be particularly useful in a contact center setting, it could also apply to many other load balancing applications. Moreover, embodiments of the present invention can also be used in any application where rules are used in connection with making a decision (e.g., parallel processing architecture).

It is, therefore, another aspect of the present invention to provide a routing engine that employs a state map which compresses routing decisions and results of comparisons into a single bit. The comparisons/determinations can be made a priori and the routing engine only has to refer to the bit map and see if it is allowed to route a work item to a particular target. If the bit has one value (e.g., a logical ‘0’), then the routing engine decides not to route the work item and if the bit has another value (e.g., a logical ‘1’), then the routing engine decides to route the work item. Therefore, routing decisions are made very quickly without the need to perform a comparison for every routing decision. The values of bits within the bit map are only changed when certain thresholds are met. In other words, each bit in the bit map is associated with a set of rules and the value of that bit is controlled by those rules. The value of the bit is changed only when the associated rules require. As one example, a bit map having a size of 64 bits could be used to replace 64 policies, providing 2 orders of magnitude improvement in performance.

In accordance with at least some embodiments of the present invention, a method is provided that generally comprises:

receiving a work item at a work item routing mechanism, the work item routing mechanism being adapted to route work items among a plurality of processing resources;

performing, by the work item routing mechanism, a bit value comparison of a bit value for the work item with a corresponding bit value for a processing resource in the plurality of processing resources; and

based on the bit value comparison, routing the work item to a selected processing resource among the plurality of processing resources.

As can be appreciated by one of skill in the art, a work item can include a contact or any other type of processing request. As used herein a contact is understood to include voice calls, emails, chat, video calls, fax, Instant Messages (IMs), collaboration software, desktop sharing, conferences, and combinations thereof. A processing request may include any type of request for a processing resource (such as a processor and/or memory) to commit its resources to the processing request for a predetermined amount of time. A web-page request is but one example of a processing request that may be considered a work item in accordance with at least some embodiments of the present invention. Accordingly, a contact center may be equipped to handle any one or a number of the above-noted work items.

These and other advantages will be apparent from the disclosure of the invention(s) contained herein. The above-described embodiments and configurations are neither complete nor exhaustive. As will be appreciated, other embodiments of the invention are possible utilizing, alone or in combination, one or more of the features set forth above or described in detail below.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

### BRIEF DESCRIPTION OF THE DRAWINGS

FIG. 1 is a block diagram depicting a communication system in accordance with embodiments of the present invention;

FIG. 2 is a block diagram depicting resource data in accordance with embodiments of the present invention;

FIG. 3 is a block diagram depicting a set of resource bit tables representing a processing resource in accordance with embodiments of the present invention;

FIG. 4 is a block diagram depicting a set of resource bit tables representing a plurality of processing resources in accordance with embodiments of the present invention;

FIG. 5 is a block diagram depicting an exemplary construction of resource bit tables in accordance with embodiments of the present invention; and

FIG. 6 is a flow chart depicting an exemplary work item routing method in accordance with embodiments of the present invention.

### DETAILED DESCRIPTION

The invention will be illustrated below in conjunction with an exemplary communication system. Although well suited for use with, e.g., a system using a server(s) and/or database(s), the invention is not limited to use with any particular type of communication system or configuration of system elements. Those skilled in the art will recognize that the disclosed techniques may be used in any computing application in which it is desirable to route work items.

The exemplary systems and methods of this invention will also be described in relation to analysis software, modules, and associated analysis hardware. However, to avoid unnecessarily obscuring the present invention, the following description omits well-known structures, components and devices that may be shown in block diagram form, are well known, or are otherwise summarized.

For purposes of explanation, numerous details are set forth in order to provide a thorough understanding of the present invention. It should be appreciated, however, that the present invention may be practiced in a variety of ways beyond the specific details set forth herein.

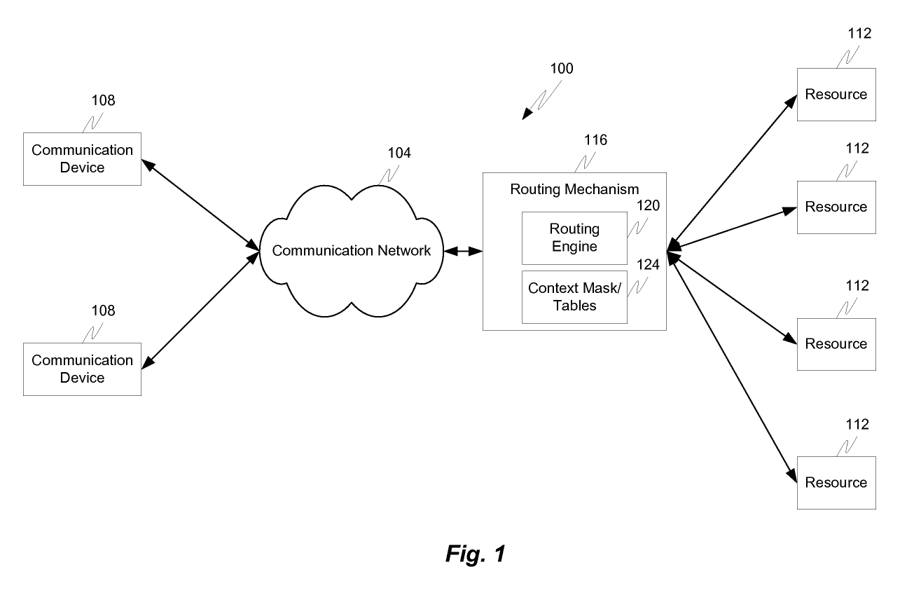

FIG. 1 shows an illustrative embodiment of a distributed communication system 100 in accordance with at least some embodiments of the present invention. The communication system 100 comprises a communication network 104 connecting one or more communication devices 108 to a routing mechanism 116.

In accordance with at least some embodiments of the present invention, the communication network 104 may comprise any type of known communication medium or collection of communication mediums and may use any type of protocols to transport messages between endpoints. The communication network 104 may include wired and/or wireless communication technologies. The Internet is an example of the communication network 104 that constitutes and IP network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a cellular network, and any other type of packet-switched or circuit-switched network known in the art. In addition, it can be appreciated that the communication network 104 need not be limited to any one network type, and instead may be comprised of a number of different networks and/or network types. Moreover, the communication network 104 may comprise a number of different communication mediums such as coaxial cable, copper cable/wire, fiber-optic cable, antennas for transmitting/receiving wireless messages, and combinations thereof.

The communication devices 108 may correspond to customer communication devices. In accordance with at least some embodiments of the present invention, a customer may utilize their communication device 108 to initiate a work item, which is generally a request for a processing resource 112. Exemplary work items include, but are not limited to, a contact directed toward and received at a contact center, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof.

The format of the work item may depend upon the capabilities of the communication device 108. In accordance with at least some embodiments of the present invention, the communication devices 108 may comprise any type of known communication equipment or collection of communication equipment. Examples of a suitable communication device 108 include, but are not limited to, a personal computer, laptop, Personal Digital Assistant (PDA), cellular phone, smart phone, telephone, or combinations thereof. In general each communication device 108 may be adapted to support video, audio, text, and/or data communications with other communication devices 108 as well as the processing resources 112. The type of medium used by the communication device 108 to communicate with other communication devices 108 or processing resources 112 may depend upon the communication applications available on the communication device 108.

In accordance with at least some embodiments of the present invention, the work item is sent toward a collection of processing resources 112 via the routing mechanism 116. The routing mechanism 116 comprises a routing engine 120 which enables the routing mechanism 116 to make intelligent routing decisions for the work item. More specifically, the routing engine 120 can determine which of the plurality of processing resources 112 is eligible to receive the work item and further determine which of the plurality of processing resources 112 is best suited to handle the processing needs of the work item.

In accordance with at least some embodiments of the present invention, the routing mechanism 116 may further comprise a context mask and/or collection of bit tables 124. The context mask/bit tables 124 may be used by the routing engine 120 to make routing decisions. In accordance with embodiments of the present invention, at least one bit table for each of the processing resources 112 may be included in the context mask/bit tables 124 of the routing mechanism 116. Therefore, the routing engine 120 may be adapted to perform bit comparisons when making work item routing decisions. The bit values of each bit table may be controlled by resources 112 and may only be altered when certain state changing event occur. The definition of a state changing event may vary depending upon the business rules used for making routing decisions as well as the meaning of values in the bit tables. However, some examples of a state changing event include, without limitation, a processing resource 112 changing its availability state (e.g., from online/available to online/unavailable or from online to offline), a processing resource 112 changing its processing capabilities (e.g., an increase or decrease in total processor capacity, an increase or decrease in total memory capacity, etc.), and a processing resource 112 exceeding a usage threshold (e.g., a predetermined percentage, such as 80% of processing capacity is currently being committed to processing work items or memory usage is above a predetermined threshold).

Furthermore, particularly in a contact center setting, a user, such as a contact center agent, may also have his/her abilities considered in the context mask/bit tables 124. Thus, other examples of a state changing event includes, without limitation, an agent changing his/her skill set, an agent changing his/her proficiency with respect to a particular skill, an agent changing his/her preference for employing a particular skill, an agent changing his/her availability state, and combinations thereof. In the absence of such a state changing event, the bit values in the context mask/bit tables 124 may not change. It may also be preferable to define state changing events in such a way that the context mask/bit tables 124 do not have their bit values changed with a great amount of frequency. By enabling the resources 112 to change their own bit table the routing mechanism 116 may not be required to proactively request state information from each resources 112 (and every agent associated with a resource) every time a work item is received. This decreases the amount of messaging required to make work item routing decisions and also increases the efficiency with which such decisions can be made.

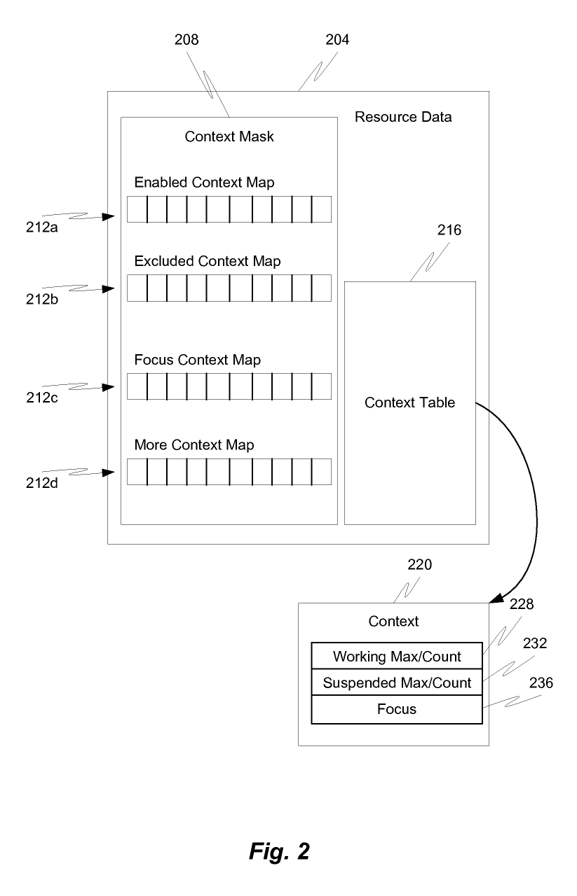

Additional details and exemplary formats of the context mask/bit tables 124 will now be described in further detail in accordance with at least some embodiments of the present invention. Referring now to FIG. 2, an exemplary context mask 208 for a resource 112 and/or a user of the resource 112 will be described in accordance with at least some embodiments of the present invention. From here forward, the context mask 208 and/or any associated bit tables will be referred to as a resource's 204 context mask 208 and/or bit table although one skilled in the art will appreciate that such a context mask 208 and/or bit table can also be used to represent a user of a resource 112.

A context mask 208 for a resource 204 may be stored in the routing mechanism 116 as depicted in FIG. 1 and may comprise one or more bit tables 212a-d. Although four bit tables 212a-d are depicted, one skilled in the art will appreciate that a greater or lesser number of bit tables 212 may be provided for a particular resource 204. Examples of the types of bit tables that may be included in the context mask 208 include, but are not limited to, an enabled context map 212a, an excluded context map 212b, a focus context map 212c, and an additional content context map 212d. It should be appreciated by those skilled in the art that the context maps 212 may have a plurality of bits with a corresponding plurality of bit values. These values tend to change infrequently over time, particularly because the values represent a set of business decisions or rules applied to a state of a resource 112. For example, if a resource's 112 processor utilization is above a particular threshold (where the threshold is determined by business rules or policies), then the value of a corresponding bit may be set to a predetermined value (e.g., a logical ‘1’). If, however, the resource's 112 processor utilization is below the particular threshold, then the value of the corresponding bit is set to a different predetermined value (e.g., a logical ‘0’). Therefore, the value of the bits in the context maps 212 do not change every time the processor utilization of the resource 112 changes, but rather only change when the processor utilization rises above or falls below the predetermined threshold. In this sense, a routing decision or part of a routing decision can be compressed to a bit value maintained at the routing mechanism 116 and there is no need for the routing mechanism 116 to continually request state information from all of the resources 112 or execute calculations and comparisons.

The resource data 204 may also include a context table 216 that includes a number of contexts 220, which may be determined by needs of a work item or other environmental concerns. The types of fields that may be included in the context 220 include certain business rules that can define how and when the context maps 212 should be altered. For instance, the context 220 may include a working maximum count threshold 228, a suspended maximum count threshold 232, and a focus 236. The thresholds may be dictated by certain business rules and may be used during modification of a context map 212. The focus 236 may also be used to determine context, but the contents of the focus field 236 may be dictated by a received work item. Thus, the routing engine 120 may be able to simultaneously alter the focus 236 of all resource data 204, thereby resulting in an altered context 220. This altered context 220 can be used to alter one or more of the context maps 212, which will then be analyzed by the routing engine 120 to determine whether a resource 112 is eligible to receive the work item based on the context as well as whether the resource 112 is the best suited resource to receive the work item.

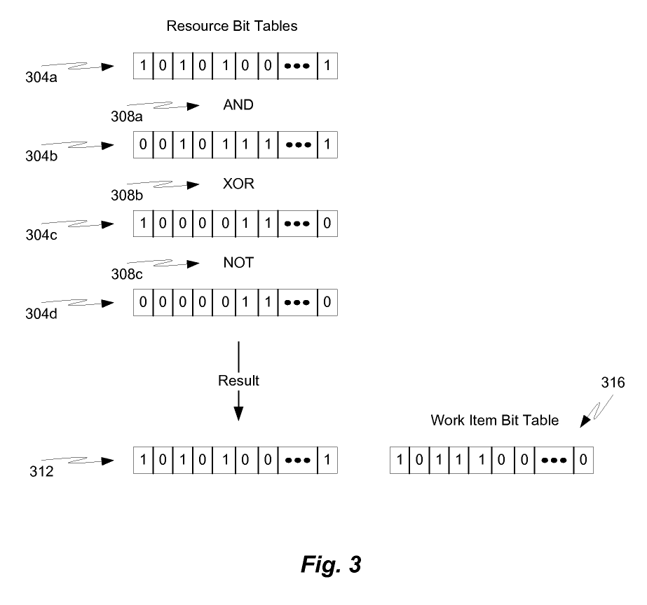

In accordance with at least some embodiments of the present invention, however, the context maps 212 may be modified to suit processing needs of a work item. As can be seen in FIG. 3, if a work item has a particular processing need (e.g., a specific agent skill or language capability) is required to service the work item, then a resource's bit table 304 (which may correspond to one or more of the resource's context maps 212) can be modified with a Boolean operation 308, such as an AND, XOR, NOT, or OR operation. The type of operation 308 used to modify a resource's bit table 304 may vary depending upon the needs of the work item, which ultimately controls the context 220.

As one non-limiting example, a first bit table 304a may be altered with a first Boolean operation 308a, thereby resulting in a second bit table 304b. This second bit table 304b may be analyzed to determine whether the resource 112 is eligible to receive the work item. Alternatively, the context may be further refined or focused based on network requirements or limitations (e.g., bandwidth utilization thresholds). If this is the case, then the second bit table 304b may be further refined with a second Boolean operation 308b, thereby resulting in a third bit table 304c. This third bit table 304c represents the resource's 112 capabilities in the context of the work item's processing needs and the network limitations.

As can be appreciated by those skilled in the art, the context may be further refined or focused to define certain exclusions, such as business rules defining that a particular type of contact center agent is not allowed to receive the work item (e.g., because the agent is training for a particular skill and the work items requires a very high level of proficiency for that skill). In this situation, the third bit table 304c may be altered with another Boolean operation 308c, thereby resulting in a fourth bit table 304d.

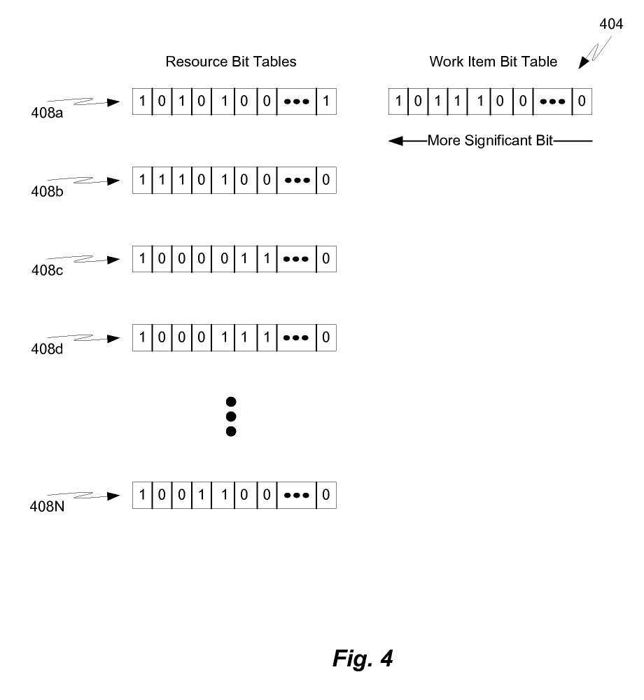

This process can be repeated as many times as is necessary to adequately define the context 220. The modifications of the original bit table 304a result in a context-based bit table 312 for the resource 112. This context-based bit table 312 can then be compared to the work item, or more specifically a work item bit table 316 to determine if the resource 112 is eligible to receive the work item and or whether the resource 112 is the best suited resource among the plurality of resources 112 to receive the work item 112. In accordance with at least some embodiments of the present invention, the comparison of the context-based bit table 312 to the work item bit table 316 may be performed on a bit-by-bit basis starting at the most significant bit of the context-based bit table 312 and the work item's bit table 316. This process is depicted in more detail in FIG. 4.

As can be seen in FIG. 4, each resource 112 may comprise a bit table 408a-N, which may correspond to either an original bit table 304a of each resource 112 or a context-based bit table 312 of each resource 112. Each resource bit table 408a-N may be compared to the work item bit table 404 on a bit-by-bit basis. The comparison may start at the most significant bit of each resource bit table 408 and the most significant bit of the work item bit table 404. In accordance with at least some embodiments of the present invention, the resource bit tables 408 are ordered based on context and the most significant bit is the most significant routing decision for the work item. Generally speaking, the most significant bit may correspond to whether the resource is currently online and available to process the work item. The bits in the resource bit tables 408 are ordered to correspond to the bits in the work item bit table 404. Therefore, value matches between a bit in a resource bit table 408 and a bit in the work item bit table 404 indicate that the resource 112 meets that particular processing need of the work item.

In other words, the most significant bit in the resource bit table 408 corresponds to one or more of state information, skill level, skill proficiency, and skill preferences of the processing resource 112 and the most significant bit the work item bit table 404 has the same meaning. Thus, when the corresponding most significant bits are compared to one another, the routing engine 120 knows that it is comparing the processing needs of the work item with the corresponding processing capabilities of the resource 112. The comparison of resource bit tables 408 with the work item bit table 404 may be performed to determine an eligibility of the resource to receive the work item or to determine the best resource 112 for receiving the work item.

In accordance with at least some embodiments of the present invention, the routing engine 120 may be adapted to perform a two-part analysis during work item routing. More particularly, the routing engine 120 may first determine which resources 112 are eligible to receive the work item (or conversely determine which resources are ineligible to receive the work item). Once a set of resources 112 have been determined to be ineligible, the routing engine 120 may further analyze the eligible resources 112 to further determine which resource among the remaining resources 112 is the best resource to receive the work item. Thus, the eligibility comparisons may be performed on a first set of most significant bits (e.g., the first three or four significant bits) and then the ultimate routing decision can be based on a further analysis of the remaining most significant bits in the resource bit tables 408a-N. In other words, bit position may be used to determine preference or score for best match algorithms.

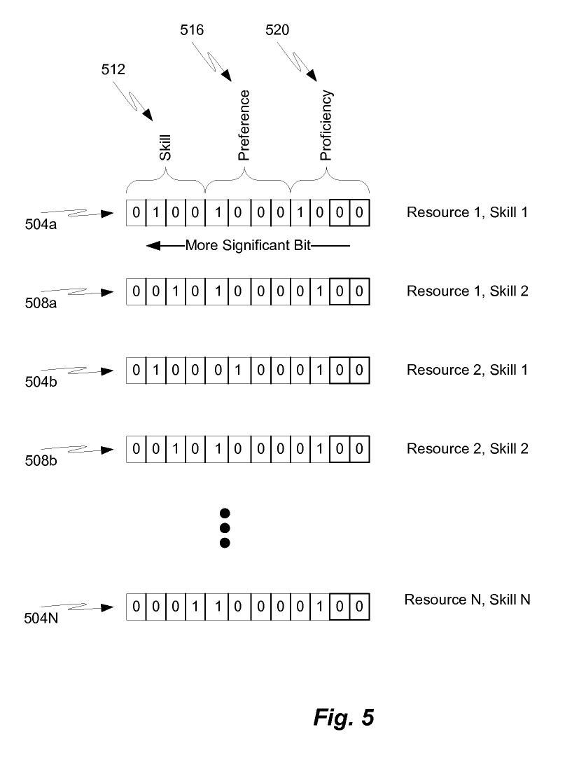

In the example depicted in FIG. 3, if the first three most significant bits were being used to determine the eligibility of resources 112, then only the resource 112 corresponding to the first resource bit table 408a would be considered eligible since none of the other depicted resource bit tables match the first three most significant bits of the work item bit table 404. If, however, there were two or more resources 112 that were deemed to be eligible resources, then the routing engine 120 may be further adapted to scan the resource bit tables 408 in a bit-by-bit fashion comparing each resource bit table 408 against the other resource bit tables 408 to determine which resource 112 is the best resource to receive the work item. This process is depicted in further detail in FIG. 5.

As can be seen in FIG. 5 and in accordance with at least some embodiments of the present invention, each resource 112 may have a number of bit tables 504, 508 organized in a context-based fashion to help determine which resource 112 is the best suited resource to receive a work item. Although two bit tables 504, 508 are depicted per resource 112, one skilled in the art will appreciate that a greater or lesser number of bit tables may be used during work item routing. Again, each of the bit tables 504, 508 may be organized with a most significant bit and a least significant bit. In the example depicted in FIG. 5, the each bit table 504, 508 for a resource corresponds to a particular skill or processing capability of the resource 112. The skill for the bit table 504, 508 may be identified in a skill portion of the bit table 512. Each bit in the skill portion 512 may identify a particular skill that is possibly available to a resource 112 and a value predetermined value in that bit (e.g., a logical ‘1’ in the depicted example) may indicate that the resource possesses the corresponding skill. If the resource 112 does not have the corresponding skill, then either that resource 112 may not have the corresponding bit table 504, 504 or an opposite value (e.g., a logical ‘0’ in the depicted example) may be placed in the bit location for that skill.

In the depicted example, at least two resources 112 have been identified as eligible to receive the work item. The work item may have at least two needs (e.g., skills 2 and 3). Both the first and second resources possess the corresponding skills as is shown in the skill portion 512 of the bit tables 504a, 504b, 508a, and 508b. Once the routing engine 120 has determined that the resource 112 is eligible, then the routing engine 120 will further analyze the resource bit tables 504, 508 to determine which resource is best suited to receive the work item. In accordance with at least some embodiments of the present invention, the resource bit tables 504 may further comprise a preference portion 516 and a proficiency portion 520. The preference portion 516 identifies the resource's 112 preference for handling the corresponding skill and the proficiency portion 520 identifies the resource's proficiency for handling the corresponding skill. Since the bit tables 504, 508 are organized with more significant bits further toward the left, the routing engine 120 is capable of determining which resource 112 has a higher preference for handling each skill by simply scanning the preference portion 516 from the most significant bit in that portion 516 toward the least significant bit until a predetermined (e.g., non-zero value) is found. As can be appreciated, non-zero as used herein may actually refer to a logical ‘1’ or any value which identifies that the resource possesses that preference for the corresponding skill. As can be further appreciated, the term “scanning” as used herein should not be limited to a bit-by-bit scanning of tables. Rather, it may be possible to scan a table by referencing and comparing multiple bits at the same time. As another example, it may be possible to reference and compare words or entire bit maps during a scanning process. Furthermore, skills may also be organized according to more significant bits, where more significant skills correspond to a skill which is a higher priority for the work item than less significant skills. Thus, the first bit tables 504a, 504b may be analyzed first to determine if one resource 112 has a higher preference for the highest priority skill. Since the first resource has a higher preference for the first skill, that resource may be considered the best resource for the work item and the routing engine 120 may route the work item to that resource 112.

If both resources had the same preference for the highest priority skill, then the routing engine 120 may be adapted to either compare the resource proficiencies for the highest priority skill to determine which resource is the best or the routing engine 120 may continue by comparing the resource preferences 516 for the next highest priority skill. The order in which preferences and proficiencies are compared to determine the best resource for a work item may vary depending upon needs of the work item, may vary depending upon the differences in preferences, or may be determined by other business rules helping to define a context.

In accordance with at least some embodiments of the present invention, the routing engine 120 may simply scan the resource bit tables 504, 508 in a bit-by-bit manner from the most significant bit toward the least significant bit until a non-zero value is found in one of the bit tables 504. If the other resource does not also have a non-zero value for that same bit position, then the routing engine 120 may stop analyzing the bit tables and may simply determine that the resource with the highest positioned non-zero value is the best resource 112 for receiving the work item. This can greatly simplify the work item routing decision and further increase the quickness with which work items are routed to a resource 112.

It has been shown that the decisions which affect work item routing may be incorporated into a single bit value and the organization of bit tables (e.g., having more and lesser significant bit positions). By intelligently organizing the resource and work item bits tables according to context, the routing engine 120 is relieved of making many routing decisions. Instead, the routing engine 120 can simply scan the intelligently organized bit tables and quickly make a routing decision based on where predetermined values are located in the bit tables.

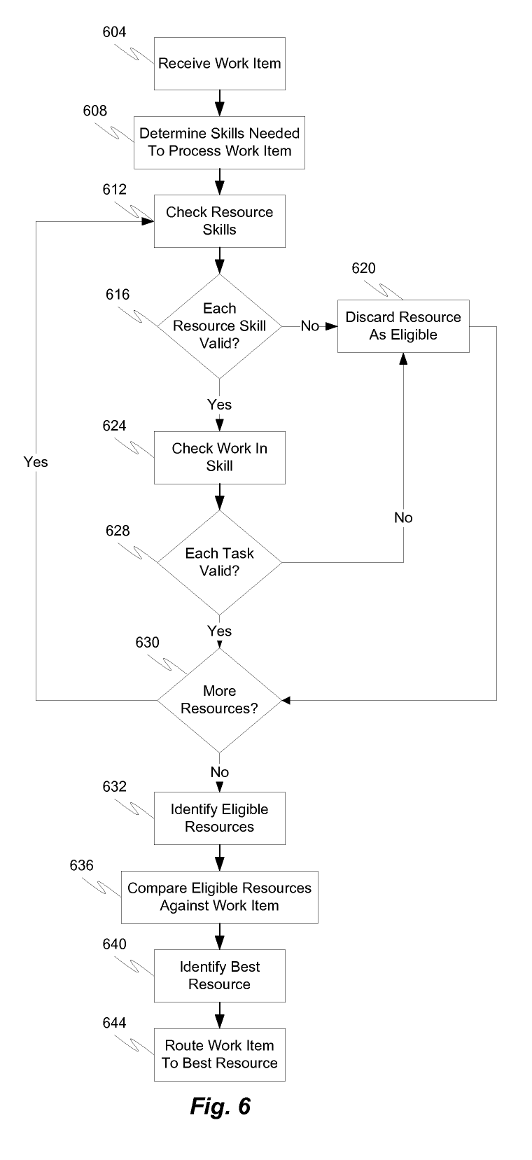

Referring now to FIG. 6, an exemplary work item routing method will be described in accordance with at least some embodiments of the present invention. The method is initiated when a work item is received at the routing mechanism 116 (step 604). The routing mechanism 116 then invokes its routing engine 120 to determine the processing needs (e.g., agent skills, processing capacity, memory capacity, etc.) of the work item (step 608). Based on the needs of the work item, the routing engine 120 may be adapted to modify resource bit tables based on context, where the context is at least partially determined by the processing needs of the work item but may also be based on other conditions.

Once the resource bit tables have been intelligently modified or organized according to the context, the routing engine 120 is adapted to analyze the resource bit tables of a first resource 112 in the plurality of resources, possibly by comparing some or all of the resource bit tables with a work item bit table to determine if the first resource is eligible or ineligible to receive the work item based on whether the first resource comprises the necessary skills to handle the work item (step 612). If the first resource does not have all of the necessary skills to handle the work item (step 616), then the routing engine 120 will continue by discarding the first resource as an ineligible resource 112 from the decision making process (step 620). If, however, the first resource possesses the necessary skills, then the routing engine 120 will continue by analyzing the work in each skill (step 624) to determine if the work in each skill can be supported by the first resource 112 (step 628). This can be done by analyzing a separate bit table of the resource or by analyzing a different portion of the same bit table that was previously analyzed in steps 612 and 616. If the resource successfully passes this analysis, then the first resource is determined to be eligible. If it fails the inquiry of step 628, then the routing engine 120 discards the first resource as ineligible (step 620).

Regardless of whether or not the first resource is eligible or not, the method then proceeds with the routing engine 120 determining if more resources 112 need to be analyzed for their eligibility (step 630). As an alternative to analyzing each resource 112 individually, the routing engine 120 may be adapted to analyze the eligibility of multiple resources in the plurality of resources at the same time.

After all of the resources have been analyzed for eligibility, the method continues with the routing engine 120 identifying all of the eligible resources (step 632). The eligible resources are then analyzed by the routing engine 120 and compared against the work item (step 636). More specifically, the routing engine 120 may compare one or more bit tables of the eligible resources against the work item bit table until a best resource is identified (step 640). Once the routing engine 120 has identified the best resource for the work item, the method continues with the routing engine 120 routing the work item to the identified best resource (step 644).

While the above-described flowchart has been discussed in relation to a particular sequence of events, it should be appreciated that changes to this sequence can occur without materially effecting the operation of the invention. Additionally, the exact sequence of events need not occur as set forth in the exemplary embodiments. The exemplary techniques illustrated herein are not limited to the specifically illustrated embodiments but can also be utilized with the other exemplary embodiments and each described feature is individually and separately claimable.

The systems, methods and protocols of this invention can be implemented on a special purpose computer in addition to or in place of the described communication equipment, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a communications device, such as a server, personal computer, any comparable means, or the like. In general, any device capable of implementing a state machine that is in turn capable of implementing the methodology illustrated herein can be used to implement the various communication methods, protocols and techniques according to this invention.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The analysis systems, methods and protocols illustrated herein can be readily implemented in hardware and/or software using any known or later developed systems or structures, devices and/or software by those of ordinary skill in the applicable art from the functional description provided herein and with a general basic knowledge of the communication arts.

Moreover, the disclosed methods may be readily implemented in software that can be stored on a storage medium, executed on a programmed general-purpose computer with the cooperation of a controller and memory, a special purpose computer, a microprocessor, or the like. In these instances, the systems and methods of this invention can be implemented as program embedded on personal computer such as an applet, JAVA®, or a domain specific language, as a resource residing on a server or computer workstation, as a routine embedded in a dedicated communication system or system component, or the like. The system can also be implemented by physically incorporating the system and/or method into a software and/or hardware system, such as the hardware and software systems of a communications device or system.

It is therefore apparent that there has been provided, in accordance with the present invention, systems, apparatuses and methods for quickly and efficiently routing work items to processing resources. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

What is claimed is:

1. A method, comprising:
receiving a work item at a work item routing mechanism, the work item routing mechanism being adapted to route work items among a plurality of processing resources;
performing, by the work item routing mechanism, a bit value comparison of a bit value for the work item with a corresponding bit value for a processing resource in the plurality of processing resources; and
based on the bit value comparison, routing the work item to a selected processing resource among the plurality of processing resources.

2. The method of claim 1, wherein the work item routing mechanism comprises a bit table for the processing resource, wherein each bit in the bit table for the processing resource comprises a value that expresses at least one of state information, skill level, skill proficiency, and skill preferences of the processing resource, and wherein the bit value comparison comprises comparing the value of at least one bit from the bit table for the processing resource to a value of a corresponding at least one bit from a work item bit table that expresses a processing need or desire of the work item.

3. The method of claim 2, further comprising modifying the bit table for the processing resource with at least one of an AND, OR, XOR, and NOT function.

4. The method of claim 3, wherein the modification of the bit table is performed to determine an eligibility of the at least one processing resource to receive the work item.

5. The method of claim 3, wherein the modification of the bit table results in a second bit table that is used to determine whether the processing resource is the best resource among the plurality of processing resources to receive the work item.

6. The method of claim 2, wherein the bit table for the processing resource comprises a most significant bit and a second most significant bit, wherein the work item bit table comprises a most significant bit and a second most significant bit, wherein the bit value comparison comprises comparing the most significant bit of the bit table for the processing resource with the most significant bit of the work item bit table, and wherein the method further comprises:
determining that the value of the most significant bit of the bit table for the processing resource is the same as the value of the most significant bit of the work item bit table; and
comparing the second most significant bit of the bit table for the processing resource with the second most significant bit of the work item bit table.

7. The method of claim 1, wherein each of the plurality of processing resources comprises a corresponding bit table, wherein each bit in a processing resource's bit table comprises a value that expresses at least one of state information, skill level, skill proficiency, and skill preferences of the processing resource, wherein bit tables of each of the plurality of processing resources are organized with a most significant bit and a least significant bit, the method further comprising:
scanning a first bit table of a first resource, wherein the scanning begins at the most significant bit and moves toward the least significant bit;
identifying a first non-zero value in the first bit table;
identifying a bit location corresponding to the first non-zero value in the first bit table;
scanning a second bit table of a second resource, wherein the scanning begins at the most significant bit and moves toward the least significant bit;
identifying a first non-zero value in the second bit table;
identifying a bit location corresponding to the first non-zero value in the second bit table;
determining that the bit location corresponding to the first non-zero value in the first bit table is at a more significant bit than the bit location corresponding to the first non-zero value in the second bit table; and
determining that the first resource is a better candidate for the work item than the second resource.

8. A routing mechanism being adapted to route work items to a plurality of processing resources, the routing mechanism comprising:
a routing engine operable to receive a work item, performing a bit value comparison of a bit value for the work item with a corresponding bit value for a processing resource in the plurality of processing resources, and based on the bit value comparison, select a processing resource among the plurality of processing resources as the processing resource to receive the work item.

9. The routing mechanism of claim 8, wherein a bit table for the processing resource is maintained by the routing mechanism, wherein each bit in the bit table for the processing resource comprises a value that expresses at least one of state information, skill level, skill proficiency, and skill preferences of the processing resource, and wherein the bit value comparison comprises comparing the value of at least one bit from the bit table for the processing resource to a value of a corresponding at least one bit from a work item bit table that expresses a processing need or desire of the work item.

10. The routing mechanism of claim 9, wherein the routing engine is further operable to modify the bit table for the processing resource with at least one of an AND, OR, XOR, and NOT function.

11. The routing mechanism of claim 10, wherein the modification of the bit table is performed to determine an eligibility of the at least one processing resource to receive the work item.

12. The routing mechanism of claim 10, wherein the modification of the bit table results in a second bit table that is used to determine whether the processing resource is the best resource among the plurality of processing resources to receive the work item.

13. The routing mechanism of claim 9, wherein the bit table for the processing resource comprises a most significant bit and a second most significant bit, wherein the work item bit table comprises a most significant bit and a second most significant bit, wherein the bit value comparison comprises comparing the most significant bit of the bit table for the processing resource with the most significant bit of the work item bit table, and wherein the routing engine is further operable to determine that the value of the most significant bit of the bit table for the processing resource is the same as the value of the most significant bit of the work item bit table and compare the second most significant bit of the bit table for the processing resource with the second most significant bit of the work item bit table.

14. The routing mechanism of claim 8, wherein each processing resource in the plurality of processing resources comprises a corresponding bit table, wherein each bit in a processing resource's bit table comprises a value that expresses at least one of state information, skill level, skill proficiency, and skill preferences of the processing resource, wherein bit tables of each of the plurality of processing resources are organized with a most significant bit and a least significant bit, wherein the routing engine is further operable to scan a first bit table of a first resource, wherein the scanning begins at the most significant bit and moves toward the least significant bit, identify a first non-zero value in the first bit table, identifying a bit location corresponding to the first non-zero value in the first bit table, scan a second bit table of a second resource, wherein the scanning begins at the most significant bit and moves toward the least significant bit, identify a first non-zero value in the second bit table, identify a bit location corresponding to the first non-zero value in the second bit table, determine that the bit location corresponding to the first non-zero value in the first bit table is at a more significant bit than the bit location corresponding to the first non-zero value in the second bit table, and determine that the first resource is a better candidate for the work item than the second resource.

15. A computer program product comprising computer executable instructions stored onto a computer readable medium which, when executed by a processor of a computer, cause the processor to execute a method, the method comprising:
receiving a work item at a work item routing mechanism, the work item routing mechanism being adapted to route work items among a plurality of processing resources;
performing a bit value comparison of a bit value for the work item with a corresponding bit value for a processing resource in the plurality of processing resources; and
based on the bit value comparison, selecting a processing resource among the plurality of processing resources as the processing resource to receive the work item.

16. The computer program product of claim 15, wherein the work item routing mechanism comprises a bit table for the processing resource, wherein each bit in the bit table for the processing resource comprises a value that expresses at least one of state information, skill level, skill proficiency, and skill preferences of the processing resource, and wherein the bit value comparison comprises comparing the value of at least one bit from the bit table for the processing resource to a value of a corresponding at least one bit from a work item bit table that expresses a processing need or desire of the work item.

17. The computer program product of claim 16, wherein the method further comprises modifying the bit table for the processing resource with at least one of an AND, OR, XOR, and NOT function.

18. The computer program product of claim 17, wherein the modification of the bit table is performed to determine an eligibility of the at least one processing resource to receive the work item.

19. The computer program product of claim 17, wherein the modification of the bit table results in a second bit table that is used to determine whether the processing resource is the best resource among the plurality of processing resources to receive the work item.

20. The computer program product of claim 16, wherein the bit table for the processing resource comprises a most significant bit and a second most significant bit, wherein the work item bit table comprises a most significant bit and a second most significant bit, wherein the bit value comparison comprises comparing the most significant bit of the bit table for the processing resource with the most significant bit of the work item bit table, and wherein the method further comprises:
determining that the value of the most significant bit of the bit table for the processing resource is the same as the value of the most significant bit of the work item bit table; and
comparing the second most significant bit of the bit table for the processing resource with the second most significant bit of the work item bit table.

21. The computer program product of claim 15, wherein each of the plurality of processing resources comprises a corresponding bit table which is maintained by the work item routing mechanism, wherein each bit in a processing resource's bit table comprises a value that expresses at least one of state information, skill level, skill proficiency, and skill preferences of the processing resource, wherein bit tables of each of the plurality of processing resources are organized with a most significant bit and a least significant bit, the method further comprising:
scanning a first bit table of a first resource, wherein the scanning begins at the most significant bit and moves toward the least significant bit;
identifying a first non-zero value in the first bit table;
identifying a bit location corresponding to the first non-zero value in the first bit table;
scanning a second bit table of a second resource, wherein the scanning begins at the most significant bit and moves toward the least significant bit;
identifying a first non-zero value in the second bit table;
identifying a bit location corresponding to the first non-zero value in the second bit table;
determining that the bit location corresponding to the first non-zero value in the first bit table is at a more significant bit than the bit location corresponding to the first non-zero value in the second bit table; and
determining that the first resource is a better candidate for the work item than the second resource.
